(19) United States
(12) Patent Application Publication
(10) Pub. No.: US 2011/0278797 A1
(43) Pub. Date: Nov. 17, 2011

(54) ULTRAVIOLET CURABLE SEALANT COMPOSITIONS

(75) Inventor: Michael J. MOORE, Sylvania, OH (US)

(73) Assignee: Freudenberg-NOK General Partnership, Plymouth, MI (US)

(21) Appl. No.: 12/778,768

(22) Filed: May 12, 2010

(51) Int. Cl. B29C 65/14; F16J 15/16; C08L 75/04

(52) U.S. Cl. 277/300; 522/90; 522/28; 522/12; 156/275.5; 277/500

(57) ABSTRACT

A curable sealant composition free from volatile organic compounds. The composition comprises a urethane acrylate oligomer present in an amount from about 20% to about 60% by weight. A liquid elastomer is present in an amount from about 20% to about 60% by weight, and at least one photoinitiator present in an amount from about 0.5% to about 10% by weight. A process for sealing a dynamic seal assembly in a housing bore is also provided.

The present technology relates to a curable sealant composition. It also relates to a process for applying a curable sealant to a dynamic seal assembly.

Sealants are useful in a wide variety of applications. In one application, a sealant is provided for use with a dynamic seal assembly. For example, a bead of sealant may be applied to the outer diameter of a rotating shaft seal assembly prior to its installation into a housing or mating bore. Commercially-available sealants typically include compositions containing nitrile rubber carriers with tackifying resins, plasticizers, and fillers suspended in an organic solvent. In such compositions, the nitrile rubber may remain uncured and does not store significant elastic energy, which minimizes the potential for the seal to escape from the bore. However, those compositions contain a high level of undesirable volatile organic solvent. In addition to obvious health, safety, and environmental hazards, the time required for the solvents to dry can be very high. Additionally, certain of the uncured sealants can be very tacky, leading to difficulties in handling. Many curable sealants, on the other hand, are not widely accepted because they tend to cure having too much of an elastic property. For example, after certain sealants are formed as a bead on an outer diameter of a shaft seal and cured, they are non-pliable and remain fully intact. In certain instances, they may even roll off the outer diameter of the seal assembly during installation, similar to the rolling movement of an elastic rubber band. Accordingly, there remains a need for curable sealant compositions and that avoid volatile organic compounds while otherwise having improved properties.

### SUMMARY

The present technology provides a curable sealant composition. The composition includes a urethane acrylate oligomer present in an amount from about 20% to about 60% by weight; a liquid elastomer present in an amount from about 20% to about 60% by weight; and at least one photoinitiator present in an amount from about 0.5% to about 10% by weight. The sealant composition is free from volatile organic solvents. In various aspects, the photoinitiator may comprise a blend of two or more active components, for example, a first component to provide depth of cure and a second component to provide a tack-free surface. A dynamic seal assembly is also provided, including a shaft seal and the curable sealant described herein, wherein the sealant is configured for being disposed between the shaft seal and a housing or bore.

The present technology also provides a process for sealing a dynamic seal assembly in a housing bore. The process includes preparing a mixture free from volatile organic solvents, comprising a urethane acrylate oligomer present in an amount from about 20% to about 60% by weight; a liquid elastomer present in an amount from about 20% to about 60% by weight; and at least one photoinitiator present in an amount from about 0.5% to about 10% by weight. The mixture is deposited on an outer sealing surface of the dynamic seal assembly in a shape and thickness desired to form an uncured sealant. The uncured sealant is exposed to ultraviolet radiation for a time sufficient to cure the sealant. The dynamic sealing assembly is then inserted and sealed in the housing bore. In various aspects, depositing the mixture on the dynamic seal assembly comprises pneumatically dispensing a bead of the sealant having a thickness from about 0.5 to about 3 millimeters.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

The present technology is directed to a curable sealant composition free from volatile organic solvents. The curable sealant composition of the present technology typically includes a suitable oligomer base or carrier, such as a urethane acrylate, and a plasticizer to adjust viscosity, such as a liquid elastomer. A photoinitiator is provided to effect an appropriate cure. The composition may additionally be provided with other additives, fillers, colorants, and optional materials as are desired and known in the art.

As used herein, the term “free from volatile organic solvents” indicates that the compositions of the present disclosure are substantially or completely free from volatile organic solvents. In particular, no volatile organic solvents are intentionally added to the compositions during mixing or formulation. In this regard, use of the term “solvent” is in reference to a particular substance in which another substance is dissolved, forming a solution. To the extent a specific ingredient or component is used with the present composition that already contains a minimal amount of a particular volatile organic component, volatile organic carrier, volatile organic material, or volatile organic impurity, the overall composition of the present disclosure will have a very low volatility. Those of skill in the art will understand this very low volatility to generally mean a total volatile organic component content of an amount less than about 5%, and preferably less than about 2%, 1%, 0.5%, or about 0.1%, or less, by weight of the composition. In other words, to the extent a volatile organic component is present in the composition, it is not intended to be, nor is present in an amount that it would be useful or capable of serving as a solvent or carrier for the oligomer, elastomer, or photoinitiator components of the composition.

In various aspects, the composition can be used as a bore sealant with dynamic seal assemblies. For example, it may be provided on the outer diameter of a rotating shaft seal assembly prior to its placement or installation within a housing, or mating bore. The sealant composition is preferably compliant, and is capable of flowing to fill in and minimize the effect of small scratches or other minor imperfections of the bore surface. The sealant composition may provide a static seal that prevents or minimizes the possibility of the seal being discharged from the bore. In various aspects, after curing, the sealant composition is non-tacky when handled, yet it remains pliable upon the application of pressure. When used with a dynamic seal assembly, for example, the sealant composition may be capable of certain smearing between a shaft seal and a bore as opposed to remaining fully elastically intact.

### Oligomer

Resins and oligomers useful with the present technology include various ultraviolet (UV) curable urethane acrylates. Exemplary urethane acrylate oligomers may be provided in an amount of from about 20% to about 60% by weight of the composition, or from about 30% to about 50% by weight, and preferably from about 40% to about 50% by weight. A desirable property of the urethane acrylate oligomer includes exhibiting an elongation at break of greater than about 50%, preferably greater than about 100%. For example, an aliphatic urethane diacrylate provides outstanding extensibility and flexibility, along with good exterior durability and excellent abrasion resistance. Non-limiting examples of commercially-available urethane acrylate oligomers useful with the present technology include: Ebecryl® 8411 and Ebecryl® 4833 (from Cytec Industries of Smyrna, GA); CN973J and CN9782 (from Sartomer of Exton, Pa.); and Genomer® 4188/EHA (from Rahn of Aurora, Ill.). In certain embodiments, a siliconized urethane acrylate oligomer such as Sartomer CN990 may be used. Sartomer CN990 is an aliphatic urethane acrylate oligomer containing bound silicone, which may have enhanced slip properties. It should be understood that other equivalent urethane acrylate oligomers may be useful with the present disclosure, while presently preferred oligomers generally have a high elongation at break.

### Liquid Elastomer

The sealant compositions of the present technology may include at least one liquid elastomer. In certain aspects, reactive liquid polymers can be used. Reactive liquid polymers are typically 100% solids liquid rubbers that are used to improve certain characteristics, including toughness, flexibility, adhesion, and impact resistance of thermoset resin systems. The liquid nature generally improves the flow of the composition while cross-linking into the rubber during curing. Reactive liquid polymers useful herein generally include polymers of the family of butadiene homopolymers and acrylonitrile-butadiene copolymers with functionality at the chain ends. As a non-limiting example, the functionality may include one or more of carboxyl or epoxy groups. Certain other functionality may not be feasible, for example, functional groups that copolymerize with the urethane acrylate to form an elastic component or elastic network may not be desired. The acrylonitrile content is typically a primary criteria determining its grade. It may vary from 0 to about 25% by weight, which directly affects solubility and glass transition temperatures of the materials. Higher acrylonitrile content provides improved solvent, oil, and abrasion resistance, along with a higher glass transition temperature.

Useful acrylonitrile-butadiene (NBR) oligomers include copolymers of acrylonitrile and butadiene with a viscosity of from about 5,000 to about 500,000 centipoise (cPs) at room temperature. In certain embodiments, the NBR oligomer may have a viscosity of from about 360,000 to 640,000 cPs at room temperature, and in some embodiments, have a molecular weight (Mₙ) from about 5,000 to about 20,000. It may be present in an amount from about of 20% to about 60% by weight, preferably from about 30% to 40% by weight, or optionally from about 40% to about 60% by weight or from about 40% to about 50% by weight of the sealant composition. The NBR oligomer may include additional functionality, such as a carboxyl group, as previously described. Non-limiting examples of commercially-available acrylonitrile-butadiene oligomers include the liquid nitrile rubber of Nipol® 1312 (from Zeon of Louisville, Ky.) and Hypron™ 1300X13 (from CVC Thermoset Specialties of Moorestown, N.J.).

### Photoinitiator

In various embodiments, the sealant compositions of the present technology are curable by the action of UV radiation. Accordingly, the compositions may comprise a photoinitiator, or curative agent, to effect curing of the urethane acrylate oligomer component. The photoinitiator may be provided in an amount from about 0.5% to about 10% by weight, and preferably from about 1% to about 5% by weight. The amount should be balanced, however, as high levels may interfere with penetration and may not substantially increase the density of the crosslink. In various aspects of the technology, the photoinitiator may be provided as a mixture or blend of two or more photoinitiators or other active ingredients. This may be beneficial because it can provide more efficient production of radicals in certain cases. For example, one ingredient may be selected to provide the depth of cure and the other may be selected to provide a tack-free surface. Alternatively, or additionally, in order to obtain a good balance between surface cure and through cure, the use of two different sources of irradiation may be used; one for pre-gelation, typically a low intensity UV lamp, and the other for completion of a final cure.

Among the photoinitiators suitable for providing depth of cure are those based on monoacyl phosphine oxides (MAPO) and bis-acyl phosphine oxides (BAPO). Alphahyrdoxyketones are one of the presently preferred classes of photoinitiators for surface cure. Non-limiting examples of commercially-available photoinitiators suitable for use with the present technology include Irgacure® 1700, Irgacure® 1800, and Irgacure® 2022 (from Ciba, based in Basle, Switzerland); or a blend of Additol® CPK and Additol® TPO (from CYTEC Industries, based in Woodland Park, N.J.).

The compositions are preferably thermally stable at temperatures used to process uncured elastomer formulations, for example in mixing and extruding operations. As used herein, thermally stable means that the composition does not spontaneously form a cross-linked network; in other words, it does not prematurely cure.

The wavelength spectrum of radiation used to effect cure typically corresponds to the absorption maximum of the UV initiator and generally ranges from about 200 to about 400 nanometers, and preferably between about 300 to about 450 nanometers. Non-limiting examples of UV radiation sources include medium pressure mercury vapor lamps, electrode-less lamps, pulsed xenon lamps, and hybrid xenon/mercury vapor lamps. One or more lamps can be used together with a reflector that diffuses the radiation more evenly over the surface to be irradiated. The radiation dosage should be sufficient to cure the composition while producing a cured composition having an elongation at break of at least greater than about 50%, and preferably greater than 100%. The particular dosage will be a function of the time of exposure to the UV radiation, the distance from the UV radiation source and the power level of the radiation source. The required radiation dose can be determined, for example, by curing small samples of the curable composition and measuring physical properties, such as tensile strength, compression set, and elongation, after cure. In most instances, an acceptable degree of cure can be obtained by exposures of from about 30 to about 300 seconds using an appropriate lamp. It should be understood that certain cure times can be as short as a few seconds, depending on the radiation lamp or other source. Adjustments may be made depending on the power of the lamp or source, distribution of the output over the UV range, the thickness of the sample as well as the polymeric component, level of photoinitiator present, and level of filler present.

### Optional Materials

The compositions of the present technology may comprise a functional filler or additional agents. As referred to herein, a “functional filler” is a material that is operable to improve one or more properties of the composition. Such properties include one or more chemical or physical properties related to the formulation, function, or utility of the composition, such as physical characteristics, performance characteristics, applicability to specific end-use devices, applications, or environments, ease of manufacturing the composition, and ease of use or processing the composition after its manufacture. For example, stabilizers, wetting agents, rheology control agents, organic and inorganic fillers, pigments, colorants, fungicides, dispersing agents, adhesives, adhesion promoters, curing accelerators, tackifiers, waxes, de-aerators, mixtures thereof, and the like as known to those skilled in the art of sealant formulations may be included and are contemplated as within the scope of the technology. While certain additives may be known to exist in the prior art, the amount used with the present technology must be controlled to avoid adversely affecting the sealant characteristics. These additives may be added to the composition at various times, and may also be pre-mixed as group or additive package. Optionally, the compositions may comprise from about 0.1% to about 50% by weight of filler or additional agent. Preferably, the composition may comprise from about 1% to about 40%, or from about 10% to about 25% by weight of filler or additional agent, depending on the desired features of the composition. It should be understood that in certain embodiments, additives or fillers may be optionally incorporated as a reduction of material costs, for example, and their presence may not necessarily be essential to a specific function of the composition. The use of additives and fillers should be balanced so as to minimize or avoid any interference with the curing process.

### Methods of Manufacture

The sealant composition of the present technology may be made using various mixing and manufacturing processes. For example, the ingredients can be mixed using readily available equipment, including but not limited to, a double planetary mixer, a high shear disperser mixer with sweep arm, or a double helix mixer. In certain aspects, it may be beneficial to heat one or more of the ingredients, particularly the urethane acrylate oligomer or the acrylonitrile-butadiene oligomer in order to reduce the viscosity for ease of mixing. It may also be beneficial to mix the composition(s) under partial vacuum to minimize or avoid the entrapment of air in the mixture. A vacuum may be applied to the composition(s) following the mixing steps in order to remove any entrapped air.

Once mixed, the composition of the present technology can be applied to a desired substrate using known methods. One presently preferred method of dispensing the composition onto a substrate is by using a pneumatic dispense type system. For example, when applying the composition of the present technology for use as a sealant for a shaft seal, a bead of the sealant is pneumatically dispensed to the outer diameter of a rotating shaft seal assembly before the assembly is installed into its mating bore. In certain aspects, an exemplary pneumatic dispensing system may be a syringe type device. Other non-limiting suitable systems would include caulk-gun type dispensers, gear pump devices, and similar mechanical methods used for dispensing sealant type materials. In various aspects, the composition may be dispensed to form a sealant bead having a thickness (height or diameter) of several millimeters, for example, from about 0.5 to about 3 millimeters, and optionally up to about 5 or about 7 millimeters, or greater. It should be understood that thicker sealant beads may require additional curing time.

Once applied to a substrate, the composition may be cured using actinic radiation. In various aspects of the technology, the composition is partially or fully cured with a UV light source that emits radiation in the range from about 300 to about 450 nm, depending upon the photoinitiator used. In one aspect, the UV light source can be mounted to a continuous conveyor. In certain embodiments, it may include a fiber optic spot source. The composition may be exposed to the UV light source for a time period of several seconds to minutes, until the bead is determined to be cured to the desired level. When the composition is provided as a sealant bead, the resulting bead preferably holds its form when handled after cure. For example, it may be preferred that the bead does not fall, sink, slump, or otherwise deform when placed in an angled or substantially vertical position.

In various aspects, the sealant composition may be used with a dynamic seal assembly. Dynamic seal assemblies among those known in the art are generally constructed as annular seals that are mounted in a housing, or bore, and received about an annular rotating shaft. The sealant composition of the present technology may be used to specifically seal the assembly in the housing, or bore. For example, a bead of the sealant composition may be provided about the outer diameter of the annular seal, or directly onto whatever substrate surface that is to be sealed, and the bead is subsequently cured. The dynamic seal assembly, having the cured bead, is then inserted and sealed within the bore.

The present technology is further illustrated through the following non-limiting examples.

For each example listed in Table 1, a clean plastic container is used to mix the identified ingredients. As listed, Examples 1-10 are provided with ingredients including urethane acrylate oligomers, liquid elastomers, adhesion promoters, acrylate monomers, deaerator additives, curatives, and colorants. Each example composition is mixed for a suitable time using a Hauschild Dac 150 SpeedMixer™. After the initial mixing, each container is subsequently mixed for about one minute using a centrifugal mixer. The resulting compositions are pourable. Each mixture is applied as a bead to a steel coupon or test panel using a disposable syringe. The resulting beads are about 2 mm in height. The beads are then cured using a Fusion F300S (300 W/in) light source with a Fusion LC6B conveyor using a Fusion V bulb. Belt speeds of from about 10 to about 20 ft/min are adequate to fully cure the bead.

TABLE 1
(weight in grams)

| Supplier | Component | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|---|
| Cytec | Ebecryl 8411 | 70 | 50 | 40 | 35 | 30 | 30 | 20 | 10 | — | — |
| Emerald | Hypro | — | 20 | 30 | 35 | 40 | 50 | 60 | 70 | 40 | 40 |
| | 1300X13 | | | | | | | | | | |
| Sartomer | CN990 | — | — | — | — | — | — | — | — | 40 | — |
| Cytec | Ebecryl 168 | 16.25 | 16.25 | 16.25 | 16.25 | 16.25 | 16.25 | 16.25 | 16.25 | 16 | 16 |
| Sartomer | SR 504 | 10 | 10 | 10 | 10 | 10 | — | — | — | — | 40 |
| Evonik | Tegorad 2500 | 1 | 1 | 1 | 1 | 1 | 1 | 1 | 1 | 1 | 1 |
| Ciba | Irgacure 2022 | 2.5 | 2.50 | 2.5 | 2.5 | 2.5 | 2.5 | 2.5 | 2.5 | 3 | 3 |
| Plasticolors | Chromacure | 0.25 | 0.25 | 0.25 | 0.25 | 0.25 | 0.25 | 0.25 | 0.25 | — | — |
| | 73-30408 | | | | | | | | | | |
| | Total | 100 | 100 | 100 | 100 | 100 | 100 | 100 | 100 | 100 | 100 |
| | State of Cure | Pass | Pass | Pass | Pass | Pass | Pass | Pass | Fail | Pass | Fail |
| | Bead | Elastic | Elastic | Pliable | Pliable | Pliable | Pliable | Pliable | Pliable | Pliable | Pliable |
| | Condition | | | | | | | | | | |

A tact test is performed and a piece of polyester (cellophane) film is placed on each bead after exposure to the UV light. A 50 gram weight is applied to the surface of each film. After 30 seconds, the weight is removed and the film is pulled from each bead. The film is examined for residue from the bead. Preferably, there is no transfer of material from the bead to the film. When lateral pressure is applied to the beads of Examples 1-7, the resulting beads remain in tact; no residue is transferred to the film. However, the bead of Example 8 transferred to the polyester film. When the beads of Examples 1 and 2 are pressed with thumb pressure, the respective beads remain in tact. Upon application of enough pressure, however, the beads of Examples 1 and 2 are not pliable, and do not flow across the test substrates. The beads of Examples 1 and 2 are removed from the respective test substrates in tact, and the detached beads are elastic. By contrast, the beads of Examples 3-8 are pliable and flow when lateral pressure is applied. Example 9 is made with a siliconized urethane acrylate oligomer; it passes the tact test and remains pliable after cure. In Example 10, the urethane acrylate oligomer is replaced with ethoxylated nonylphenol mono-acrylate. Although the resulting bead of Example 10 remains pliable after cure, it fails the tact test.

The embodiments described herein are exemplary and not intended to be limiting in describing the full scope of compositions and methods of the present technology. Equivalent changes, modifications and variations of embodiments, materials, compositions and methods can be made within the scope of the present technology, with substantially similar results.

### Non-limiting Discussion of Terminology:

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “desire,” “desirable,” “prefer” and “preferable” refer to embodiments of the technology that afford certain benefits, under certain circumstances. However, other embodiments may also be desirable or preferred, under the same or other circumstances. Furthermore, the recitation of one or more desired or preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

1. A curable sealant composition, comprising:
a urethane acrylate oligomer present in an amount from about 20% to about 60% by weight;
a liquid elastomer present in an amount from about 20% to about 60% by weight; and
at least one photoinitiator present in an amount from about 0.5% to about 10% by weight,
wherein the composition is free from volatile organic solvents.

2. The curable sealant composition of claim 1, wherein the photoinitiator comprises a blend of two or more active components.

3. The curable sealant composition of claim 2, wherein the photoinitiator comprises a first component to provide depth of cure and a second component to provide a tack-free surface.

4. The curable sealant composition of claim 2, wherein the photoinitiator comprises a compound selected from the group consisting of monoacyl phosphine oxide, bis-acyl phosphine oxide, alphahydroxyketone, and mixtures thereof.

5. The curable sealant composition of claim 1, wherein the composition is cured using actinic radiation comprising ultraviolet radiation having a wavelength from about 300 to about 450 nm.

6. The curable sealant composition of claim 1, further comprising an additive selected from the group consisting of adhesion promoters, functional fillers, de-aerators, pigments, colorants, and mixtures thereof.

7. The curable sealant composition of claim 1, wherein the liquid elastomer comprises reactive liquid polymers.

8. The curable sealant composition of claim 1, wherein the liquid elastomer comprises an acrylonitrile-butadiene oligomer.

9. The curable sealant composition of claim 8, wherein the acrylonitrile-butadiene oligomer comprises a copolymer of acrylonitrile and butadiene having a viscosity of from about 5,000 centipoise to about 500,000 centipoise at room temperature.

10. The curable sealant composition of claim 9, wherein the acrylonitrile-butadiene oligomer is provided in an amount from about 40% to about 60% by weight.

11. The curable sealant composition of claim 9, wherein the acrylonitrile-butadiene oligomer comprises at least one carboxyl functional group.

12. The curable sealant composition of claim 1, wherein the urethane acrylate oligomer is provided in an amount from about 40% to about 50% by weight.

13. The curable sealant composition of claim 1, wherein the urethane acrylate oligomer exhibits an elongation at break of greater than about 50%.

14. The curable sealant composition of claim 1, wherein the urethane acrylate oligomer exhibits an elongation at break of greater than about 100%.

15. A dynamic seal assembly including a shaft seal and a bore, wherein a curable sealant composition of claim 1 is disposed between the shaft seal and the bore.

16. A process for sealing a dynamic seal assembly in a housing bore, the process comprising:
preparing a mixture free from volatile organic solvents, comprising:
a urethane acrylate oligomer present in an amount from about 20% to about 60% by weight;
a liquid elastomer present in an amount from about 20% to about 60% by weight and
at least one photoinitiator present in an amount from about 0.5% to about 10% by weight;
depositing the mixture on an outer sealing surface of the dynamic seal assembly in a shape and thickness desired to form an uncured sealant;
exposing the uncured sealant to ultraviolet radiation for a time sufficient to cure the sealant; and
inserting and sealing the dynamic sealing assembly in the housing bore.

17. The process according to claim 16, wherein the photoinitiator comprises a first component to provide depth of cure and a second component to provide a tack-free surface.

18. The process according to claim 16, wherein the liquid elastomer comprises an acrylonitrile-butadiene oligomer having at least one carboxyl functional group.

19. The process according to claim 16, wherein the liquid elastomer is provided in an amount from about 30% to about 40% by weight and the urethane acrylate oligomer is provided in an amount from about 40% to about 50% by weight.

20. The process according to claim 16, wherein depositing the mixture on an outer sealing surface comprises pneumatically dispensing a bead of the sealant having a thickness from about 0.5 to about 3 millimeters on an outer diameter of the dynamic seal assembly.
